(19) United States
(12) Patent Application Publication
(10) Pub. No.: US 2005/0182862 A1
(43) Pub. Date: Aug. 18, 2005

(54) System and method for detecting DMA-generated memory corruption in a PCI express bus system

(76) Inventors: Andrew J. Ritz, Sammamish, WA (US); Ellsworth D. Walker, Seattle, WA (US)

Correspondence Address: AMIN & TUROCY, LLP, 24TH FLOOR, NATIONAL CITY CENTER, 1900 EAST NINTH STREET, CLEVELAND, OH, 44114, US

(21) Appl. No.: 10/777,368

(22) Filed: Feb. 12, 2004

(51) Int. Cl. G06F 13/28

(52) U.S. Cl. 710/22

(57) ABSTRACT

A system and method that facilitate detection of direct memory access (DMA) corruption is provided. The system can mitigate DMA memory corruption in computer system(s) employing transaction-based DMA bus system(s) (e.g., PCI Express). DMA transaction(s) cannot normally be traced; however, in accordance with an aspect of the present invention, the system is extended to include an interface to specify “allowed” and/or “disallowed” memory range(s) for a DMA transaction. If a DMA transaction occurs in a disallowed range, then it is rejected and, optionally, an error is raised. Thus, the system of the present invention can facilitate detection of direct memory access transaction(s) that can, if permitted, cause memory corruption. The system includes an access information data store (e.g., access table) and a memory controller. The access information can include, for example, a source identifier, a memory range (e.g., one or more contiguous memory address(es)) and access attribute(s) (e.g., read access, read and write access, write access, no access permitted, etc.).

### TECHNICAL FIELD

The present invention relates generally to computer system(s), and, more particularly, to a system and method for detecting direct memory access (DMA)-generated memory corruption in (e.g., a PCI express bus system).

### BACKGROUND OF THE INVENTION

Memory corruption is a longstanding reliability problem in computer systems, and in general is the problem that occurs when some entity in a computer system alters memory in an unexpected location. When this altered memory is consumed by another portion of the system, the memory's contents are unexpected, which can result in a system crash or data corruption. Several techniques have been developed that allow code running on the CPU of a computer system to attempt to detect when corruption has occurred. When the system employs direct memory access (DMA) however, the CPU generally does not have the ability to monitor the device-to-memory DMA transaction, so it cannot detect if a corruption has occurred.

For example, a piece of hardware (e.g., a device) in the system may malfunction when it performs DMA activity. Recall that DMA is characterized by a device being programmed to read or write memory from a preprogrammed physical memory address that was reserved by the memory manager for this device. Typically, this is done by a single arbiter of the system's memory (e.g., the operating system memory manager). The device becomes a “bus master” and transfers the data into this memory location without involving the processor. As such this can facilitate more efficient overall system IO and frees-up the processor to perform other work concurrently while the DMA memory transaction is in process. If, however, the device writes into an improper memory address then a memory corruption occurs. This memory corruption cannot be caught by the operating system memory manager at the exact instance when the memory corruption occurs because the processor is not involved in the memory transaction. For example, a DMA transaction into an incorrect memory location can occur, and, the corrupted memory consumed by the system before a polling agent of the operating system can detect the memory corruption. Thus, despite the fact that the operating system has detected the memory corruption, the damage has already been done in that the corrupted memory has already been consumed by the system.

This corruption can be caused, for example, by a device driver, either misprogramming the DMA engine for a device, misusing operating system provided DMA/memory management API(s), and/or other similar error. This corruption can also be caused by the hardware malfunctioning, for example, having a latching problem in the DMA engine (causing a validly programmed address to become invalid), or otherwise having a bus error.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention provides for a system and method that facilitate detection of direct memory access (DMA) corruption. The system can mitigate DMA memory corruption by employing transaction-based DMA bus system(s) (e.g., PCI Express) by rejecting disallowed transaction(s). In accordance with an aspect of the present invention, the system is extended to include an interface to specify “allowed” and/or “disallowed” DMA transactions. If a disallowed DMA transaction occurs, then it is rejected and, optionally, an error is raised. For example, the determination of whether a transaction can be allowed can be based on a source identifier and/or memory address(es) involved.

Thus, the system of the present invention can facilitate detection of direct memory access transaction(s) that can, if permitted, cause memory corruption. The system can further facilitate identification (e.g., to the operating system) of the direct cause of the transaction(s) (e.g., PCI Express source identifier) that, if permitted, can cause memory corruption.

For example, if a device attempts a DMA write into a piece of memory that has been logically marked as “read-only”, such as the memory location in which the operating system kernel instructions have been loaded into, then this would be intercepted and rejected by the system.

The system includes an access information data store (e.g., access table) and a memory controller. The access information data store (e.g., access table) stores access information associated with memory. In one example, the access information is stored in an access table. The access information can include, for example, a source identifier, a memory range (e.g., one or more contiguous memory address(es)) and access attribute(s) (e.g., read access, read and write access, write access, no access permitted.). The memory controller employs the access information to determine whether a requested direct memory access is permitted and rejects the requested direct memory access if it is not permitted. If the requested DMA access it not permitted, the memory controller can, optionally, provide error information (e.g., to the operating system).

In one example, PCI Express bus packet(s) are utilized. For memory transaction(s) (e.g., read and/or write), a packet is formed that includes a requester ID (e.g., source identifier), a transaction type (e.g., memory read or memory write) and memory address(es). The requester ID (e.g., source identifier) identifies the source of a memory transaction. The system can employ the requester ID (e.g., source identifier) to identify a source of a disallowed DMA memory transaction.

Another aspect of the present invention provides for a direct memory access memory corruption detection system having a memory controller having an access table. The memory controller is coupled to device(s) via a transaction-based bus (e.g., PCI Express bus). In one example, the system further includes a device driver, DMA API(S) and a memory manager. The device driver programs the device for a DMA read and/or write operation. The device driver further employs the DMA API(s) to allocate a region of physical memory for the device to use for DMA. The physical address is then programmed into the DMA engine for the device. When the device driver calls into the DMA API(s), the operating system programs information into the memory controller. For example, a range of physical memory, a source identifier and/or access information can be provided to the memory controller and stored in the access table.

After programming this new “row” of information into the memory controller access table, the memory controller can monitor for memory transaction(s) in the particular range of memory and/or by the particular source (e.g., identified by the source identifier). Thereafter, the device attempts to perform a DMA transaction and provides a request to the memory controller via the transaction based bus (e.g., employing a PCI express bus packet). The memory controller determines whether the requested DMA transaction is allowed. For example, the memory controller can determine if the address of the memory transaction is in one of the allowed ranges. If so, it determines whether a source of the requested DMA transaction is the same as the source identifier stored with the allowed range in the access table. Finally, the memory controller determines whether the requested DMA transaction type matches the access attribute(s) stored in the access table. If the condition(s) are met, the memory controller permits the requested DMA memory transaction to proceed. If the conditions are not met, the memory controller can reject the memory access along with, optionally, providing error information to the CPU. For example, error information could be provided to the operating system executing on the CPU (e.g., via a corrected platform error (CPE) event).

Thus, the memory controller can differentiate between an allowed range for one source (e.g., based on source identifier) and an allowed range for substantially all sources.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a block diagram of a direct memory access memory corruption detection system in accordance with an aspect of the present invention.

FIG. 2 is a block diagram of a direct memory access memory corruption detection system in accordance with an aspect of the present invention.

FIG. 3 is a diagram of an exemplary access table in accordance with an aspect of the present invention.

FIG. 4 is a block diagram of a direct memory access memory corruption detection system in accordance with an aspect of the present invention.

FIG. 5 is a block diagram of a direct memory access memory corruption detection system in accordance with an aspect of the present invention.

FIG. 6 is a flow chart of a method that facilitates detection of direct memory access memory corruption in accordance with an aspect of the present invention.

FIG. 7 illustrates an example operating environment in which the present invention may function.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component,” “handler,” “model,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). Computer components can be stored, for example, on computer readable media including, but not limited to, an ASIC (application specific integrated circuit), CD (compact disc), DVD (digital video disk), ROM (read only memory), floppy disk, hard disk, EEPROM (electrically erasable programmable read only memory) and memory stick in accordance with the present invention.

The system and method of the present invention facilitate detection of direct memory access memory transaction(s) that can, if permitted, cause memory corruption. For purposes of explanation, the present invention will be described in the context of a PCI Express bus. However, those skilled in the art will recognize that any suitable bus can be employed and all such types of buses are intended to fall within the scope of the hereto appended claims.

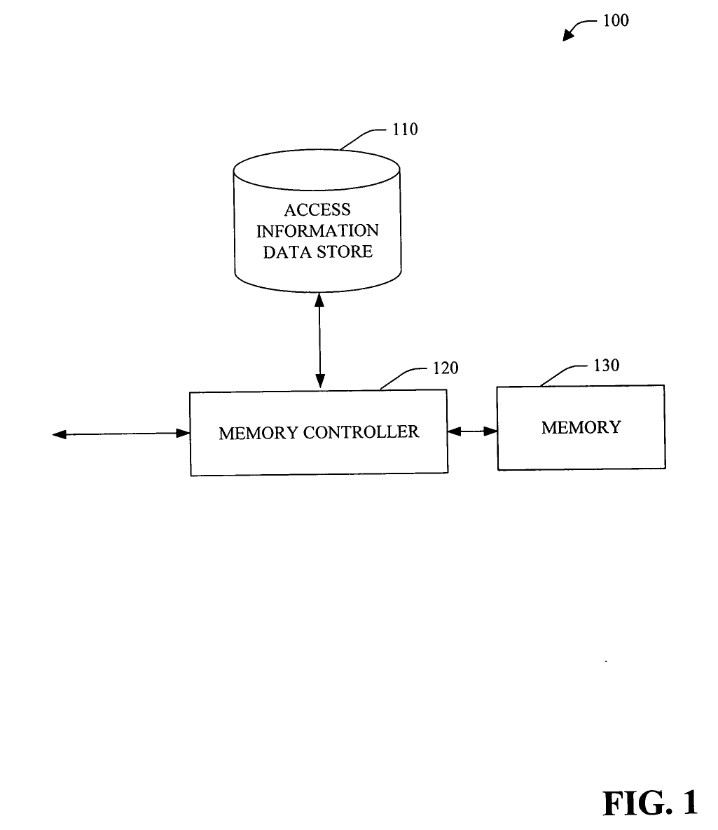

Referring to FIG. 1, a direct memory access memory corruption detection system 100 in accordance with an aspect of the present invention is illustrated. The system 100 can facilitate detection of direct memory access transaction(s) that can, if permitted, cause memory corruption. Historically, memory corruption is a major point of user dissatisfaction with computer system(s) and/or operating system(s). The system 100 can mitigate DMA memory corruption by employing transaction-based DMA bus system(s) (e.g., PCI Express). As noted previously, DMA transaction(s) occur outside the processor and cannot normally be traced, however the system 100 is extended to include an interface to specify “allowed” and/or “disallowed” memory range(s) for a DMA transaction. If a DMA transaction occurs in a disallowed range, then it is rejected and, optionally, error information is provided to the operating system running on the processor.

For example, if a device attempts a DMA write into a piece of memory 130 that has been logically marked as “read-only”, such as the memory location in which the operating system kernel instructions have been loaded into, then a request associated with the attempted DMA write is intercepted and rejected by the system 100.

The system 100 includes an access information data store 110 and a memory controller 120. The access information data store 110 stores access information associated with memory 130. In one example, the access information is stored in the access information data store 110 in a table. The access information can include, for example, a source identifier, a memory range (e.g., one or more contiguous memory address(es)) and access attribute(s) (e.g., read access, read and write access, write access, no access permitted, etc.). The memory controller 120 employs the access information to determine whether a requested direct memory access is permitted and rejects the requested direct memory access if it is not permitted. If the requested DMA access it not permitted, the memory controller 120 can, optionally, provide error information (e.g., to the operating system) via mechanisms such as a corrected platform error (CPE) signal. It is to be appreciated that the system 100, the access information data store 110 and/or the memory controller 120 can be computer components as that term is defined herein.

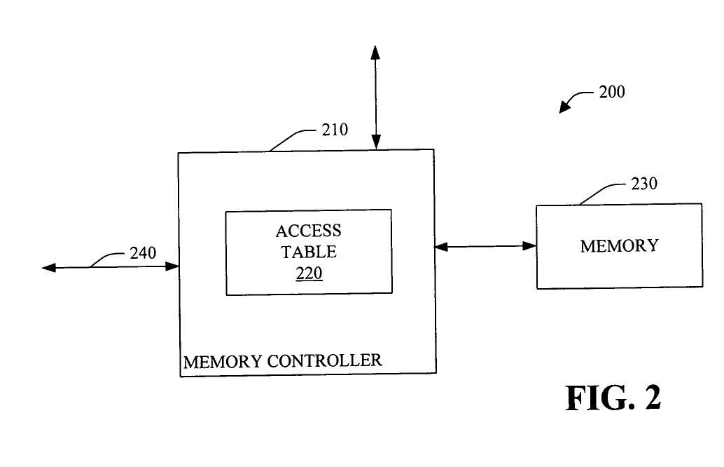

Turning to FIG. 2, a direct memory access memory corruption detection system 200 in accordance with an aspect of the present invention is illustrated. The system 200 includes a memory controller 210 having an access table 220. The memory controller facilitates access to memory 230.

Briefly, the Peripheral Component Interface (PCI) Express is a high performance, general purposes I/O interconnect defined for a wide variety of future computing and communication platforms. The PCI Express architecture includes three discrete logical layers: the transaction layer, the data link layer and the physical layer. PCI Express uses packets to communicate information between components. Packets are formed in the transaction and data link layers to carry the information from the transmitting component to the receiving component. For memory transaction(s) (e.g., read and/or write), a packet is formed that includes a requester ID (e.g., source identifier), a transaction type (e.g., memory read or memory write) and memory address(es). The requester ID (e.g., source identifier) identifies the device which is the source of a memory transaction. The packet includes additional fields discussion of which is omitted for purposes of brevity. The PCI Express bus includes a source identifier for memory transaction(s) that includes “bus device function” style identification.

In this example, the memory controller 230 is coupled to device(s) (not shown) via a PCI Express bus 240. At system initialization, for example, the memory controller 230 receives access information regarding device(s) which is stored in the access table 220.

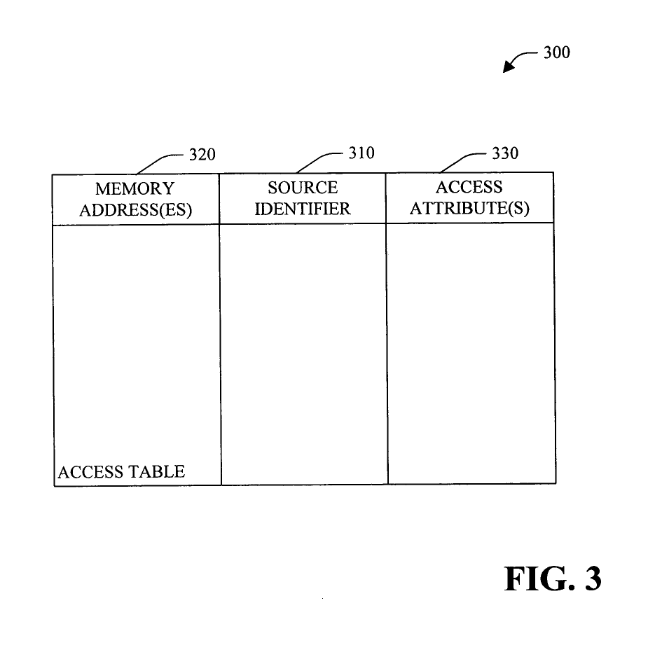

Referring briefly to FIG. 3, an exemplary access table 300 in accordance with an aspect of the present invention is illustrated. The access table 300 includes a source identifier field 310, a memory address(es) field 320 and a access attribute(s) field 330. The source identifier field 310 includes unique identifying information regarding potential requester(s) of DMA transaction(s) (e.g., device(s)). For example, in a PCI-Express system, the source identifier field would correspond to the source address in a PCI-Express packet.

The memory address(es) field 320 includes information regarding memory address(es) (e.g., memory address range) associated with the potential requester(s) of DMA. For example, the memory address(es) field 320 can identify a permissible address range for DMA to be performed for a particular device. In another example, the memory address(es) field 320 includes a disallowed address range for which DMA is not permissible (e.g., for a particular device and/or substantially all device(s)). The access attribute(s) field 330 include information associated with the particular source identifier and memory address(es). For example, the attribute(s) field 330 can include read, read and write, write, no access permitted.

Returning to FIG. 2, the memory controller 210 can utilize the information stored in the access table 220 to determine whether a requested DMA transaction is permissible. Significantly, the fact that the access table 220 has not been populated can also be meaningful as the system 200 can, in one example, infer that no restrictions on DMA transaction(s) exist.

If the requested DMA transaction is permissible, the memory controller 210 can facilitate access to memory 230. If the requested DMA transaction is not permissible, the memory controller 210 can, optionally, provide error information to the operating system (e.g., source identifier associated with impermissible requested DMA transaction).

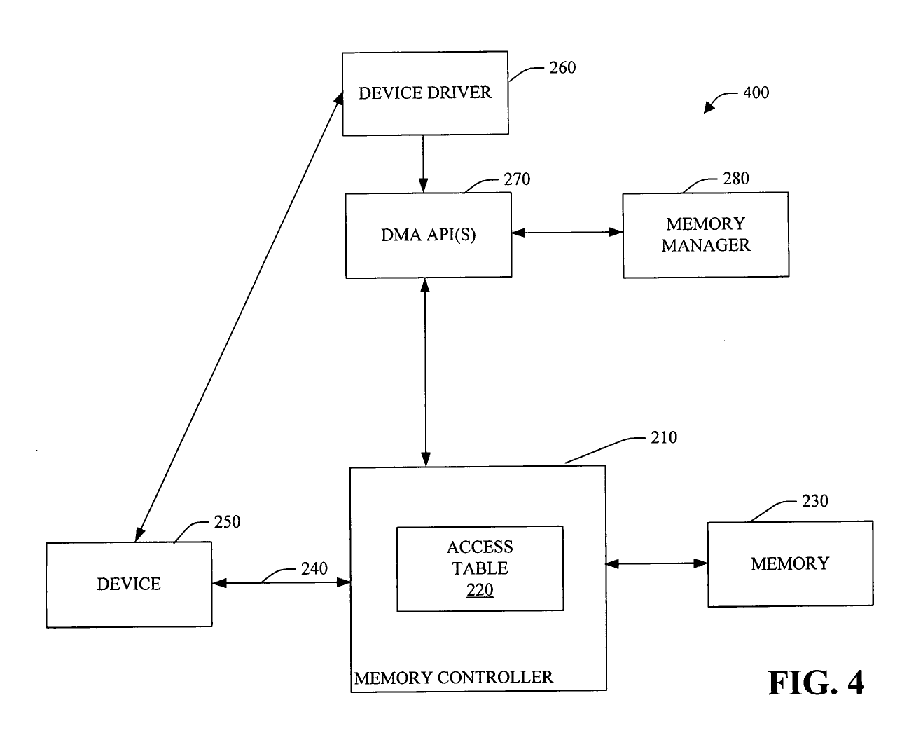

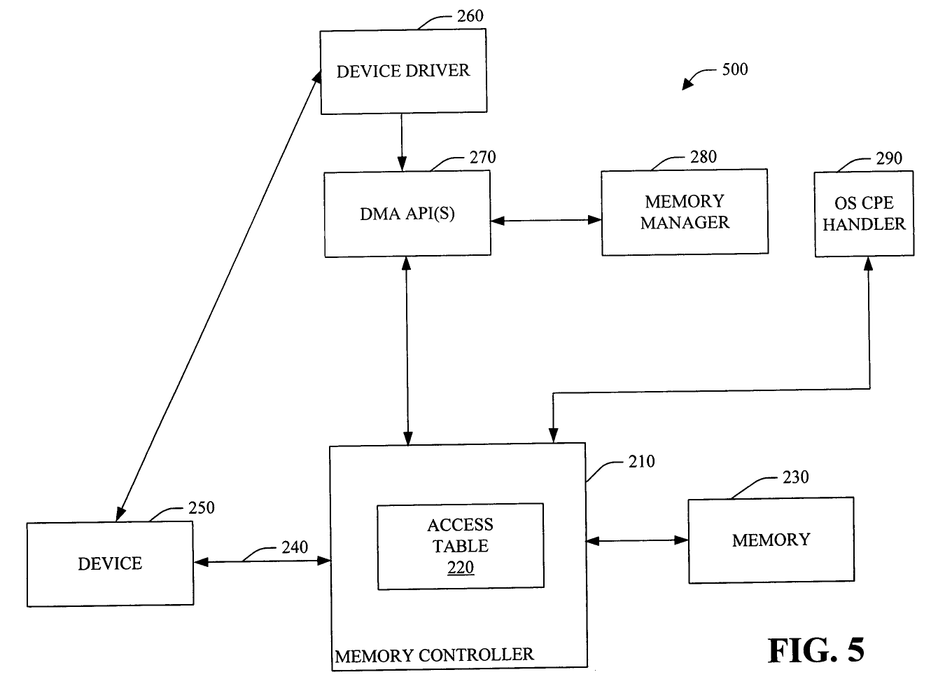

Next, turning to FIG. 4, a direct memory access memory corruption detection system 400 in accordance with an aspect of the present invention is illustrated. The system 400 includes a memory controller 210 having an access table 220, the memory controller facilitating access to memory 230. The memory controller 230 is coupled to a device 250 via a transaction-based bus (e.g., PCI Express bus) 240. The system 400 further includes a device driver 260, direct memory access operating system application programming interface(s) (DMA API(s)) 270 and/or a memory manager 280. As illustrated in FIG. 5, the system 400 can further include, optionally, an operating system CPE handler 290.

In this example, the device driver 250 further employs the DMA API(s) 270 to arbitrate with the operating system memory manager for a suitable physical memory location for the DMA transaction. The operating system memory manager 280 and/or the DMA APIs 270 will reserve some physical memory 230 for this purpose so that no other data can be placed into it (e.g., by virtual memory mapping for the physical memory). The physical address is then programmed into the DMA engine for the device 250 by device driver 260.

When the device driver 260 calls into the DMA API(s) 270, the operating system programs information into the memory controller 210. For example, the following information can be provided to the memory controller 210 and stored in the access table 220:
a. A range of physical memory (e.g., represented as a base address and a length);
b. A source identifier; and,
c. Access attribute(s) (e.g., read, write, execute, no access, etc.)
   After programming this new row of information into the memory controller 210, the memory controller 210 can monitor for memory transaction(s) in the particular range of memory and/or by the particular source (e.g., identified by the source identifier).

The device driver 260 further programs the device 250 for a DMA read or write operation. Once the access table 220 has been programmed, at some point thereafter, the device 250 attempts to perform a DMA transaction. The device 250 provides a request to the memory controller 210 via the transaction based bus 240 (e.g., employing a PCI express bus packet). In one example, the memory controller 210 determines whether the requested DMA transaction is in one of the allowed ranges. If so, it determines whether a source of the requested DMA transaction is the same as the source id stored with the allowed range in the access table 220. Finally, the memory controller 210 determines whether the requested DMA transaction type matches the access attribute(s) stored in the access table 220. In another example, the memory controller 210 checks to see if there are any entry(ies) for the specified source identifier before looking for allowed/disallowed transaction(s).

In this example, if the conditions are met, the memory controller 210 permits the requested DMA memory transaction to proceed. If the conditions are not met, the memory controller 210 can, optionally, provide error information, for example, to the operating system. In one example, the memory controller 210 can provide a corrected platform error (CPE) event to operating system. At some later point, the device 250 can interrupt the processor to let it know that the transaction is complete. The operating system memory manager 280 and/or DMA APIs 270 can then release the device's memory allocation and the memory controller 210 can be un-programmed (e.g., associated entry of access table 220 removed). In the event that a CPE event is provided, the operating system is notified (e.g., via an interrupt and/or polling mechanism). For example, in order to facilitate correction of the source of the error, information associated with the non allowed requested DMA transaction (e.g., source identifier, address(es) and/or access attribute(s)) can be provided to the operating system.

In this example, a DMA access control list (e.g., stored in the access table 220) that provides access to certain memory range(s) has been described. However, in another example, the system 400 can facilitate a “negative” DMA access control list (e.g., access table 220) that identifies range(s) of address(es) for which DMA access is not permitted. In this example, the memory controller 210 is provided with memory address(es) for which DMA engines are prohibited from accessing (e.g., from the operating system). For instance, driver executable code can be identified as “off limits” for DMA. Thus, the system 400 can facilitate detection DMA memory transaction(s) that, if completed, can corrupt the memory 230. The system 400 can accordingly increase reliability of operating system(s), system code, hardware, device drivers, etc.

The system 400 can further allow for fine-grained detection of the source of memory corruption. It can increase the reliability of hardware as well, by isolating hardware components that are more prone to causing DMA corruptions.

Error Reporting

The PCI Express bus includes a source identifier for memory transaction(s) that includes “bus device function” style identification. With this, fairly detailed information regarding a potential source of memory corruption can be identified. As noted previously, optionally, the memory controller 210 can provide error information via a CPE event to the operating system CPE handler 290.

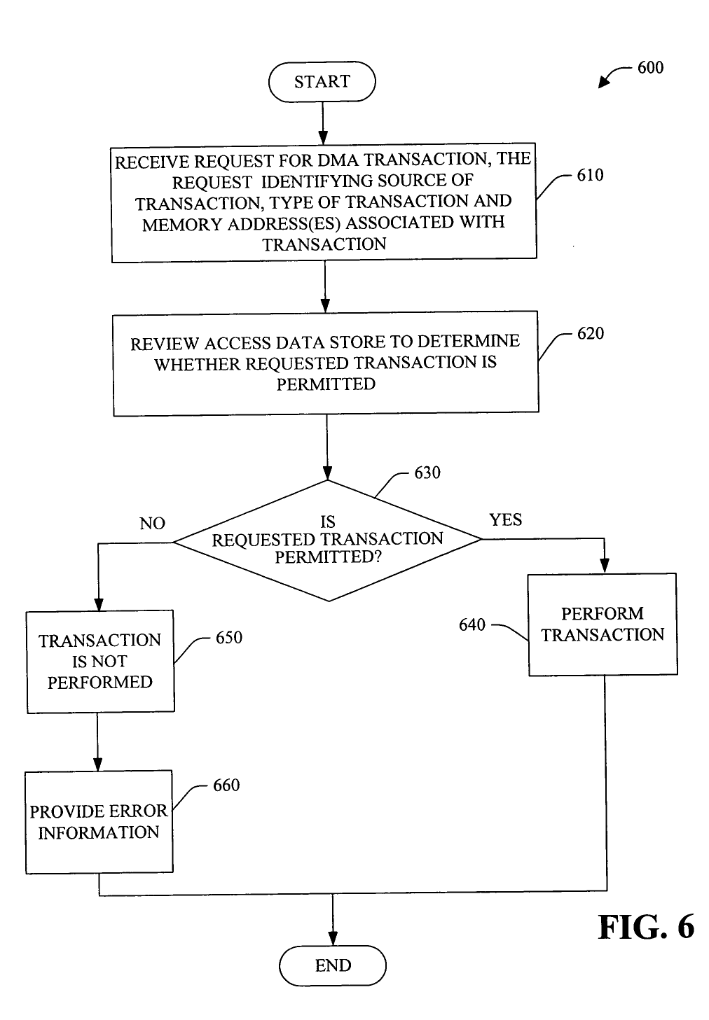

Turning briefly to FIG. 6, a methodology that may be implemented in accordance with the present invention are illustrated. While, for purposes of simplicity of explanation, the methodologies are shown and described as a series of blocks, it is to be understood and appreciated that the present invention is not limited by the order of the blocks, as some blocks may, in accordance with the present invention, occur in different orders and/or concurrently with other blocks from that shown and described herein. Moreover, not all illustrated blocks may be required to implement the methodologies in accordance with the present invention.

The invention may be described in the general context of computer-executable instructions, such as program modules, executed by one or more components. Generally, program modules include routines, programs, objects, data structures, etc. that perform particular tasks or implement particular abstract data types. Typically the functionality of the program modules may be combined or distributed as desired in various embodiments.

Referring to FIG. 6, a method that facilitates detection of direct memory access memory corruption 600 in accordance with an aspect of the present invention is provided. At 610, a request for a DMA transaction is received (e.g., from a device). The request includes a source identifier, a type of transaction (e.g., read, write, etc.) and memory address(es) associated with the requested transaction. At 620, an access data store (e.g., access table 220) is reviewed in order to determine whether the requested transaction is permitted. The information stored in the access data store can include, for example, a source identifier, memory address(es) and access attribute(s) (e.g., received from a device driver via DMA API(s)).

At 630, a determination is made as to whether the requested transaction is permitted (e.g., based, at least in part, upon information stored in the access data store, and, the requested transaction information). If the determination at 630 is YES, at 640, the transaction is performed, and, no further processing occurs. If the determination at 630 is NO, at 650, the transaction is not permitted. At 660, error information is provided (e.g, to an operating system), and, no further processing occurs.

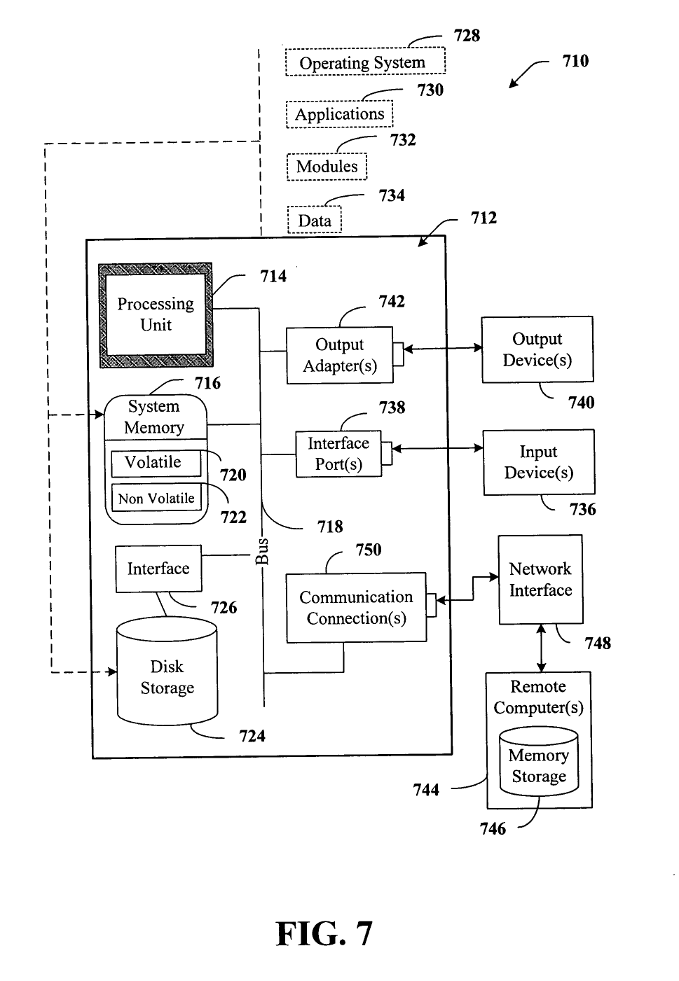

In order to provide additional context for various aspects of the present invention, FIG. 7 and the following discussion are intended to provide a brief, general description of a suitable operating environment 710 in which various aspects of the present invention may be implemented. While the invention is described in the general context of computer-executable instructions, such as program modules, executed by one or more computers or other devices, those skilled in the art will recognize that the invention can also be implemented in combination with other program modules and/or as a combination of hardware and software. Generally, however, program modules include routines, programs, objects, components, data structures, etc. that perform particular tasks or implement particular data types. The operating environment 710 is only one example of a suitable operating environment and is not intended to suggest any limitation as to the scope of use or functionality of the invention. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 7, an exemplary environment 710 for implementing various aspects of the invention includes a computer 712. The computer 712 includes a processing unit 714, a system memory 716, and a system bus 718. The system bus 718 couples system components including, but not limited to, the system memory 716 to the processing unit 714. The processing unit 714 can be any of various available processors. Dual microprocessors and other multiprocessor architectures also can be employed as the processing unit 714.

The system bus 718 can be any of several types of bus structure(s) including the memory bus or memory controller, a peripheral bus or external bus, and/or a local bus using any variety of available bus architectures including, but not limited to, an 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), PCI-Express, remote DMA (RDMA), Universal Serial Bus (USB), Advanced Graphics Port (AGP), Personal Computer Memory Card International Association bus (PCMCIA), and Small Computer Systems Interface (SCSI).

The system memory 716 includes volatile memory 720 and nonvolatile memory 722. The basic input/output system (BIOS), containing the basic routines to transfer information between elements within the computer 712, such as during start-up, is stored in nonvolatile memory 722. By way of illustration, and not limitation, nonvolatile memory 722 can include read only memory (ROM), programmable ROM (PROM), electrically programmable ROM (EPROM), electrically erasable ROM (EEPROM), or flash memory. Volatile memory 720 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 712 also includes removable/nonremovable, volatile/nonvolatile computer storage media. FIG. 7 illustrates, for example a disk storage 724. Disk storage 724 includes, but is not limited to, devices like a magnetic disk drive, floppy disk drive, tape drive, Jaz drive, Zip drive, LS-100 drive, flash memory card, or memory stick. In addition, disk storage 724 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 724 to the system bus 718, a removable or non-removable interface is typically used such as interface 726.

It is to be appreciated that FIG. 7 describes software that acts as an intermediary between users and the basic computer resources described in suitable operating environment 710. Such software includes an operating system 728. Operating system 728, which can be stored on disk storage 724, acts to control and allocate resources of the computer system 712. System applications 730 take advantage of the management of resources by operating system 728 through program modules 732 and program data 734 stored either in system memory 716 or on disk storage 724. It is to be appreciated that the present invention can be implemented with various operating systems or combinations of operating systems.

A user enters commands or information into the computer 712 through input device(s) 736. Input devices 736 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 714 through the system bus 718 via interface port(s) 738. Interface port(s) 738 include, for example, a serial port, a parallel port, a game port, and a universal serial bus (USB). Output device(s) 740 use some of the same type of ports as input device(s) 736. Thus, for example, a USB port may be used to provide input to computer 712, and to output information from computer 712 to an output device 740. Output adapter 742 is provided to illustrate that there are some output devices 740 like monitors, speakers, and printers among other output devices 740 that require special adapters. The output adapters 742 include, by way of illustration and not limitation, video and sound cards that provide a means of connection between the output device 740 and the system bus 718. It should be noted that other devices and/or systems of devices provide both input and output capabilities such as remote computer(s) 744.

Computer 712 can operate in a networked environment using logical connections to one or more remote computers, such as remote computer(s) 744. The remote computer(s) 744 can be a personal computer, a server, a router, a network PC, a workstation, a microprocessor based appliance, a peer device or other common network node and the like, and typically includes many or all of the elements described relative to computer 712. For purposes of brevity, only a memory storage device 746 is illustrated with remote computer(s) 744. Remote computer(s) 744 is logically connected to computer 712 through a network interface 748 and then physically connected via communication connection 750. Network interface 748 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 750 refers to the hardware/software employed to connect the network interface 748 to the bus 718. While communication connection 750 is shown for illustrative clarity inside computer 712, it can also be external to computer 712. The hardware/software necessary for connection to the network interface 748 includes, for exemplary purposes only, internal and external technologies such as, modems including regular telephone grade modems, cable modems and DSL modems, ISDN adapters, and Ethernet cards.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A direct memory access memory corruption detection system comprising:
an access data store that stores access information associated with memory; and,
a memory controller that employs the access information to determine whether a requested direct memory access is permitted and rejects the requested direct memory access if it is not permitted.

2. The direct memory access memory corruption detection system of claim 1, the access information comprising an access attribute.

3. The direct memory access memory corruption detection system of claim 2, the access attribute comprising one of read, read and write, and, write access.

4. The direct memory access memory corruption detection system of claim 1, the access information comprising a source identifier.

5. The direct memory access memory corruption detection system of claim 4, the source identifier being associated with a device.

6. The direct memory access memory corruption detection system of claim 1, the access data store comprising an access table, the access table comprising a source identifier field, a memory address field and an access attribute field.

7. The direct memory access memory corruption detection system of claim 1, the access information comprising at least one permitted memory address.

8. The direct memory access memory corruption detection system of claim 1, the access information comprising at least one disallowed memory address.

9. The direct memory access memory corruption detection system of claim 1, the request comprising a read action or a write action.

10. The direct memory access memory corruption detection system of claim 1, the request comprising a PCI Express bus transaction.

11. The direct memory access memory corruption detection system of claim 1, the memory controller coupled to a device through a PCI Express bus, the device providing the request.

12. The direct memory access memory corruption detection system of claim 1, the memory controller further providing error information, if the requested direct memory access is not permitted.

13. The direct memory access memory corruption detection system of claim 12, the error information comprising source information associated with the requested direct memory access.

14. A direct memory access memory corruption detection system comprising:
a memory controller that includes an access table store that stores access information associated with memory, the memory controller employs the access information to determine whether a requested direct memory access is permitted and rejects the requested direct memory access if it is not permitted; and,
a device driver that programs a device for a direct memory access operation, and, provides the access information to the memory controller via a direct memory access application interface.

15. The direct memory access memory corruption detection system of claim 14, the stored access information comprising a range of physical memory, a source identifier, and, an access attribute.

16. The direct memory access memory corruption detection system of claim 14, the request comprising a PCI Express bus transaction.

17. A method that facilitates detection of direct memory access memory corruption comprising:
receiving a request for a direct memory access transaction, the request comprising a source identifier, at least one memory address, and a transaction access attribute; and,
determining whether the request is permitted based, at least in part, stored access information and the request.

18. The method of claim 17, the stored access information comprising a source identifier, at least one memory address and an access attribute.

19. The method of claim 17, storing access information in a access data store, the access information comprising a source identifier, at least one memory address and an access attribute.

20. A computer readable medium having stored thereon computer executable instructions for carrying out the method of claim 17.

21. A data packet transmitted between two or more computer components that facilitates detection of direct memory access memory corruption, the data packet comprising:
a data field comprising a corrected platform error event, the corrected platform error event being based, at least in part, upon a determination that a requested direct memory access is not permitted, the determination being based, at least in part, upon access information stored in an access table and the requested direct memory access.

22. A direct memory access memory corruption detection system comprising:
means for storing access information associated with memory;
means for receiving a request for a direct memory access;
means for determining whether a requested direct memory access is permitted based, at least in part, upon the stored access information and the request; and,
means for rejecting the requested direct memory access if it is not permitted.
